(19) United States
(12) Patent Application Publication
(10) Pub. No.: US 2013/0171027 A1
(43) Pub. Date: Jul. 4, 2013

(54) OXYGEN SENSORS BASED ON HARD-SOFT ACID-BASE RELATIONSHIPS

(71) Applicants: Bogdan Catalin Serban, Bucharest (RO); Mihai N. Mihaila, Bucharest (RO); Octavian Buiu, Bucharest (RO); Stefan Dan Costea, Bucharest (RO)

(72) Inventors: Bogdan Catalin Serban, Bucharest (RO); Mihai N. Mihaila, Bucharest (RO); Octavian Buiu, Bucharest (RO); Stefan Dan Costea, Bucharest (RO)

(73) Assignee: Honeywell International Inc., Morristown, NJ (US)

(21) Appl. No.: 13/729,866

(22) Filed: Dec. 28, 2012

(30) Foreign Application Priority Data
Dec. 29, 2011 (EP) 11195977.1

(51) Int. Cl. G01N 21/64

(52) U.S. Cl. CPC G01N 21/643
USPC 422/69; 252/301.33

(57) ABSTRACT

A fluorescence quenching oxygen sensor (100) comprises a support (102) having coated thereon;
a compound having hard or soft acid groups (104); and
one or more pyrene compounds (106) represented by

Y—R-Pyrene (I)

attached to the compound having hard or soft basic groups;
wherein Y is a hard or soft basic group and R is an aliphatic linking group having 1 to 19 carbon atoms. The sensor can be used to prepare a fluorescence quenching oxygen detector.

### CROSS-REFERENCE TO RELATED APPLICATION

This application claims the benefit of priority under 35 U.S.C. Section 119 to European Patent Application Serial No. 11195977.1, filed on Dec. 29, 2011, which application is incorporated herein by reference in its entirety.

### FIELD OF THE INVENTION

This invention relates to the design of oxygen sensors based on hard-soft acid-base relationships, to methods of preparing these sensors, and to oxygen detectors incorporating these sensors.

### BACKGROUND

Determination of oxygen concentration is important in various fields such as automotive applications, medical devices, anesthesia monitors, and environmental monitoring. Recently, devices based on the fluorescence quenching of organic molecules have been developed to determine the concentration of oxygen. When exposed to light at an appropriate wavelength, the fluorescent substances absorb energy and are promoted from their ground state energy level (So) into an excited state energy level (S1). Fluorescent molecules are unstable in their excited states and can relax by different competing pathways.

Fluorescence based oxygen sensing elements work on the principle that relaxation of the S1 state can also occur through interaction with a second molecule through fluorescence quenching. Molecular oxygen (O₂) is an efficient quencher of fluorescence because of its unusual triplet ground state. Fluorophores used for oxygen sensing include: pyrene and its derivatives, quinoline, decacyclene and its derivatives, phenantrene, erythrosine B, and aluminum 2,9,16,23-tetraphenoxy-29H,31H-phthalocyaninehydroxide. These fluorophores are incorporated into a polymer matrix such as: silicones, polystyrene, and ethyl cellulose that are selectively permeable to oxygen and adhere to glass.

One difficulty with incorporating fluorescent molecules into a polymer is that the fluorescent molecule may have poor solubility and may crystallize or aggregate within the polymer matrix upon coating and drying.

It would be useful to provide oxygen sensors that do not crystallize or aggregate within the polymer matrix upon coating and drying.

### SUMMARY

A fluorescence quenching oxygen sensor comprises a support having coated thereon;

a compound having hard or soft acid groups; and

one or more pyrene compounds represented by

Y—R-Pyrene (I)

attached to the compound having hard or soft basic groups;

wherein Y is a hard or soft basic group and R is an aliphatic linking group having 1 to 19 carbon atoms;

such that the soft acid groups of the compound are attached to the soft basic groups Y on Y—R-Pyrene;

such that the hard acid groups of the compound are attached to the hard basic groups, Y, on Y—R-Pyrene.

A fluorescence quenching oxygen detector comprises a support having coated thereon;

a compound having hard or soft acid groups;

one or more pyrene compounds represented by

Y—R-Pyrene (I);

attached to the compound having hard or soft acid groups;

wherein Y is a hard or soft basic group and R is an aliphatic linking group having 1 to 19 carbon atoms;

such that the soft acid groups of the compound are attached to the soft basic groups Y on Y—R-Pyrene;

such that the hard acid groups of the compound are attached to the hard basic groups, Y, on Y—R-Pyrene;

an excitation source; and

a fluorescence detector.

A method of preparing a fluorescence quenching oxygen sensor comprises coating onto a support;

a compound having hard or soft acid groups;

overcoating the compound having hard or soft basic groups with one or more pyrene compounds represented by

Y—R-Pyrene (I);

wherein Y is a hard or soft basic group and R is an aliphatic linking group having 1 to 19 carbon atoms;

such that the soft acid groups of the compound are attached to the soft basic groups Y on Y—R-Pyrene; or

such that the hard acid groups of the compound are attached to the hard basic groups, Y, on Y—R-Pyrene.

In formula (I) R is an aliphatic linking group having from 1 to 19 carbon atoms. The aliphatic linking group may be straight chain or branched and may contain various substituents such as aliphatic groups (e.g., methyl, ethyl, propyl, iso-propyl, sec-butyl, etc.). In one embodiment, R is a straight chain alkylene group —(CH₂)ₘ— having from 1 to 19 methylene groups. In one embodiment, R is a linking group containing 9 to 19 carbon atoms. In one embodiment R is an aliphatic linking group containing 1 to 19 methylene groups containing one or more oxygen atoms. In one embodiment, when Y is a hard acid group or the anion of a hard acid group represented by —COOH or —COO⁻, then R is 9 to 19 methylene groups. In one embodiment, when Y is a soft acid group or the anion of a soft acid group represented by —SH or —S⁻ then R is 1 to 19 methylene groups, In one embodiment, when Y is a soft acid group or the anion of a soft acid group represented by —SH or —S⁻ then R is 9 to 19 methylene groups,

In formula (I), Y is a hard or soft basic group. In one embodiment Y is a carboxylic acid group, a carboxylate group, a thiol group, or the anion of a thiol group.

Other aspects, advantages, and benefits of the present invention are apparent from the detailed description, examples, and claims provided in this application.

### BRIEF DESCRIPTION OF THE DRAWINGS

FIG. 1 illustrates a fluorescence oxygen sensor according to an example embodiment.

FIG. 2 illustrates a fluorescence oxygen detector according to an example embodiment.

### DETAILED DESCRIPTION

We have found that R. G. Pearson's Hard-Soft Acid-Base (HSAB) relationships can be used to select organic polymers, inorganic fillers (metal or metal oxides) and fluorophores for oxygen sensors. The sensor can be incorporated into a fluorescence quenching oxygen detector. In particular, attachment of a pyrene fluorophore to a substrate using Pearson's hard-soft acid-base relationships provides material that can be used as a fluorescence quenching oxygen sensor and incorporated into a fluorescence quenching oxygen detector.

One method of classifying acids and bases involves the Hard-Soft Acid-Base (HSAB) relationships. This relationship, developed by R. G Pearson, applies HSAB relationships to Lewis acids and bases. HSAB relationships are used in chemistry for explaining stability of compounds, reaction mechanisms, and pathways. It assigns the terms “hard” or “soft,” and “acid” or “base” to chemical species. “Hard” applies to species which are small, have high charge states (the charge criterion applies mainly to acids, to a lesser extent to bases), and are weakly polarizable. “Soft” applies to species which are big, have low charge states, and are strongly polarizable. The Hard-Soft Acid-Base (HSAB) relationship establishes reactivity rules between molecules: hard acids prefer to react with hard bases and soft acids prefer to react with soft bases (soft likes soft, hard likes hard). Borderline acids prefer to react with borderline bases.

Non-limiting examples of hard Lewis acids include: H⁺, Li⁺, Na⁺, K⁺, Mg²⁺, Ca²⁺, Al³⁺, Cr²⁺, Fe³⁺, BF₃, B(OR)₃, AlMe₃, AlCl₃, AlH₃, SO₃, RCO⁺, CO₂, HX, I⁷⁺, Cl⁷⁺, I₅₊, Zr⁴⁺, Ti⁴⁺, Th⁴⁺, Ga³⁺, In³⁺, and La³⁺.

Non-limiting examples of soft Lewis acid includes: Cu⁺, Ag⁺, Pd²⁺, Pt²⁺, Hg²⁺, BH₃, GaCl₃, I₂, Br₂, carbenes, trinitrobenzene, chloranil, quinones, and bulk metals

Non-limiting examples of borderline Lewis acids include: Fe²⁺, Co²⁺, Cu²⁺, Zn²⁺, Sn²⁺, Sb³⁺, Bi³⁺, BMe₃, SO₂, Cr³⁺, and NO⁺.

Non-limiting examples of hard Lewis bases include: H₂O, OH⁻, F⁻, AlkylCOO⁻, SO₄²⁻, Cl⁻, CO₃²⁻, NO₃⁻, ROH, RO—, R₂O, NH₃, and RNH₂.

Non-limiting examples of soft Lewis bases include: R₂S, RSH, RS⁻, I⁻, R₃P, (RO)₃P, CN⁻, RCN, CO, C₂H₄, C₆H₆, H⁻, and R⁻.

Non-limiting examples of borderline Lewis bases include: ArNH₂, C₅H₅N (pyridine), Br⁻, and NO₂⁻.

Hard Lewis acids bind to hard Lewis bases to give charge-controlled (ionic) complexes. Such interactions are dominated by the +/− charges on the Lewis acid and Lewis base species.

Soft Lewis acids bind to soft Lewis bases to give frontier molecular orbital (FMO) controlled covalent complexes.

Using HSAB relationships, a strong interface (either ionic or covalent) can be created between the surface of the polymeric support coated with a metal oxide or bulk metal and the pyrene fluorophore. The pyrene fluorophore can be functionalized with appropriate moieties which can act as a hard, soft, or borderline acid or base.

For example, 1-pyrene decanoic acid in the form of its carboxylate salt can act as a hard base.

For example, pyrene alkane thiols, (7), (8), and (9) can act through the thiol groups, as soft bases.

Using this approach, interactions (hard acid-hard base) or covalent interactions (soft acid-soft base) can be designed for the interface.

For example, if Ti⁴⁺ (a hard acid) is present as a major species at the surface of TiO₂ metal oxide, a pyrene carboxylate can be used as a hard base. Bonding between the Ti⁺⁴ and the pyrene carboxylate is ensured by ionic interaction between anion and cation.

If on the other hand, OH is present as a major species at the surface of the TiO₂ metal oxide, the bonding between the OH and the pyrene carboxylic acid occurs via an esterification reaction and the interface is ensured by covalent bond. Alternatively, the reaction can take place with a pyrene acid chloride or a pyrene amide.

A second approach is to modulate the surface of metal oxides. For example, it has been shown that chemisorption at the TiO₂ surface through COOH groups can occur though a variety of binding modes and which one is prevalent depends on the structure of the fluorophore, the binding groups, the pH, and the metal oxide preparation.

Representative metal oxides include TiO₂, Cu₂O.

In one embodiment the pyrene is attached by an ionic carboxylate complex or an ester linkage having the structures

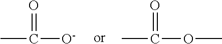

The ionic carboxylate or ester linkage may form by reaction of pyrene carboxylic acid or pyrene carboxylate (a hard base) with reactive groups on the surface of the metal or metal oxide. For example, the surface of TiO₂ contains hard acid sites as Ti⁺⁴ ions as well as OH groups. Reaction of a pyrene carboxylate (a hard base) with a hard acid Ti⁺⁴ site forms a Ti⁺⁻OOC—R-pyrene salt. Reaction of a pyrene carboxylic acid (or acid chloride or amide) with the OH site results in formation of an ester containing —OOC—R-pyrene.

In one embodiment the pyrene is attached by reaction of a soft base pyrene thiol (or its anion Pyrene-R—S⁻) with a soft acid Cu₂O to form a covalent bond.

In one embodiment, the pyrene is attached by a covalent bond between the surface of the metal (or a metal oxide) and a thiol group (or its anion Pyrene-R—S⁻).

Representative pyrene based fluorophores include: pyrene carboxylic acids, and pyrene alkyl thiols.

Specific pyrene based fluorophores represented by Y—R-Pyrene (I) include: 1-pyrene butyric acid (1), 1-pyrene decanoic acid (2), 1-pyrene dodecanoic acid (3), and 1-pyrene acetic acid (4). These pyrene carboxylic acids are commercially available from Sigma-Aldrich (St. Louis, Mo.). Additional pyrene fluorophores include 1-pyren-1-ylmethanethiol (5) and its anion (12), 5-(pyren-1-yl-methoxy)pentane-1-thiol (6) and its anion (13), 8-(pyren-1-yl-methoxy)pentane-1-thiol (7) and its anion (14), 2-(pyrene-1-yl)acetate (8), 4-(pyrene-1-yl)butanoate (9), 10-(pyrene-1-yl)decanoate (10), and 12-(pyrene-1yl)dodecanoate (11).

Structure (1) represents 1-pyrenebutyric acid.

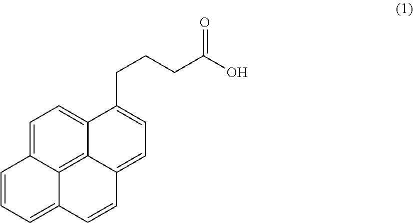 [SMILES: O=C(O)CCCc1ccc2ccc3cccc4ccc1c2c34]

Structure (2) represents 1-pyrenedecanoic acid.

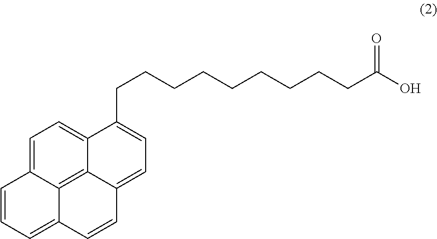 [SMILES: O=C(O)CCCCCCCCCc1ccc2ccc3cccc4ccc1c2c34]

Structure (3) represents 1-pyrenedodecanoic acid.

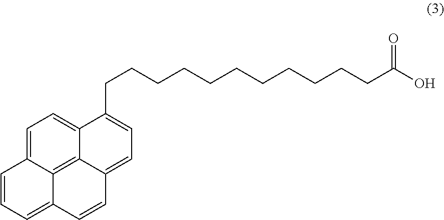 [SMILES: O=C(O)CCCCCCCCCCCc1ccc2ccc3cccc4ccc1c2c34]

Structure (4) represents 1-pyrene acetic acid.

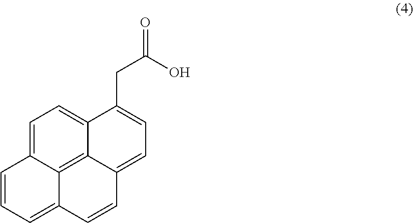 [SMILES: O=C(O)Cc1ccc2ccc3cccc4ccc1c2c34]

Structure (5) represents 1-pyrene-1-yl-methanethiol.

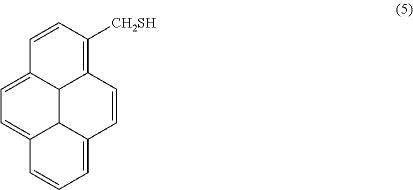

Structure (6) represents 5-(pyrene-1-yl-methoxy)pentane-1-thiol.

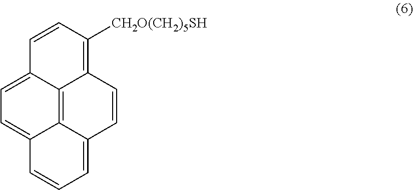

Structure (7) represents 8-(pyrene-1-yl-methoxy)pentane-1-thiol.

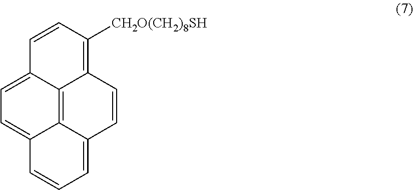

Structure (8) represents 2-(pyrene-1-yl)acetate.

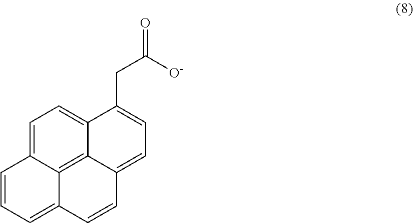 [SMILES: O=C([O-])Cc1ccc2ccc3cccc4ccc1c2c34]

Structure (9) represents 4-(pyrene-1-yl)butanoate.

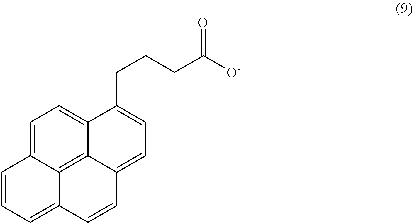 [SMILES: O=C([O-])CCCc1ccc2ccc3cccc4ccc1c2c34]

Structure (10) represents 10-(pyrene-1-yl)decanoate.

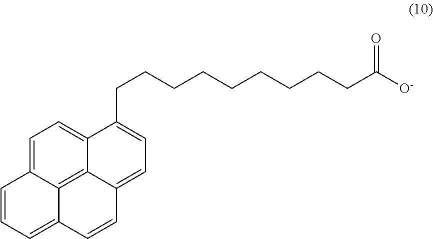 [SMILES: O=C([O-])CCCCCCCCCc1ccc2ccc3cccc4ccc1c2c34]

Structure (11) represents 12-(pyrene-1-yl)dodecanoate.

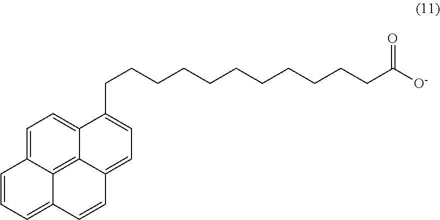 [SMILES: O=C([O-])CCCCCCCCCCCc1ccc2ccc3cccc4ccc1c2c34]

Structure (5) represents the anion of pyrene-1-yl-methanethiol.

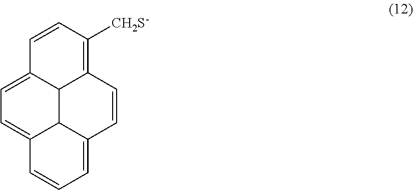

Structure (6) represents the anion of 5-(pyrene-1-yl-methoxy)pentane-1-thiol.

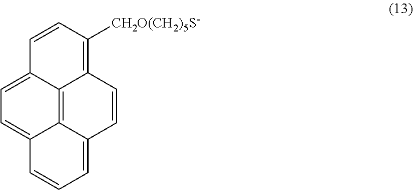

Structure (7) represents the anion of 8-(pyrene-1-yl-methoxy)pentane-1-thiol.

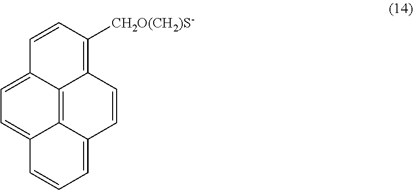

In one embodiment the oxygen sensor comprises a support. The support may be transparent, translucent, or opaque. The support may be rigid or flexible. Exemplary polymeric materials for making such supports include polyesters [such as poly(ethylene terephthalate) and poly(ethylene naphthalate)], cellulose acetate and other cellulose esters, polyvinyl acetal, polyolefins, polycarbonates, and polystyrenes. Preferred polymeric supports include polymers having good heat stability, such as polyesters and polycarbonates. Support materials may also be treated or annealed to reduce shrinkage and promote dimensional stability. Opaque supports can also be used, such metals and resin-coated papers that are stable to high temperatures. Rigid supports such as glass are particularly useful.

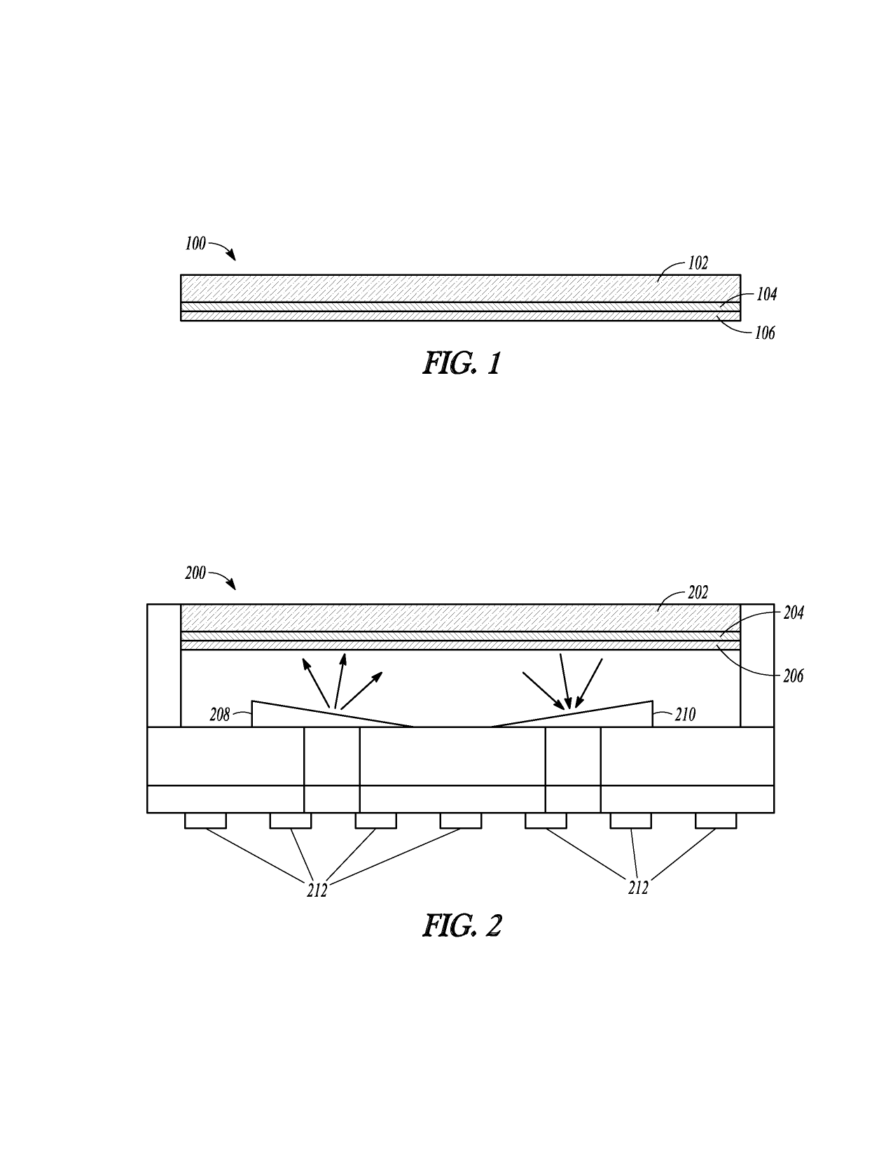

FIG. 1 shows a fluorescence quenching oxygen sensor (100). The sensor comprises a substrate or support (102) coated with a hard or soft acid (104) attached to a pyrene compound of formula (I) Y—R-Pyrene (106).

FIG. 2 shows a fluorescence quenching oxygen detector (200) incorporating the oxygen sensor (100). The detector comprises an excitation source (208), such as an LED, a fluorescence detector (210) and the optional driving and signal conditioning circuitry (212). Alternatively the driving and signal conditioning circuitry may be located separately and electronically connected to the detector.

### Preparation of Fluorescence Quenching Oxygen Sensors

A material containing a hard or soft acid is deposited onto a support. Deposition can be carried out via well-known methods, such as doctor blade coating, anodic oxidation, or electrodeposition. For example, TiO₂ can be deposited onto a support using a doctor blade method; Cu₂O can be deposited onto a support using anodic oxidation of a copper surface or electrodeposition.

The fluorescence quenching oxygen sensor can then be prepared by depositing one or more of the Y—R-Pyrene compounds of formula (I) onto the support having the appropriate compound having hard or soft acid groups coated thereon. One or more fluorescent pyrene compounds represented by formula (I) is dissolved in an appropriate solvent to form a homogeneous solution. Deposition is then carried out using any of the techniques listed above. In one embodiment, the support is dip-coated into a solution of the pyrene compound. Reaction of the compound having the appropriate hard or soft acid on the support with the appropriate hard or soft base on the Y portion of the Y—R-Pyrene compound forms the fluorescence sensor.

The coated slide is stored for three days, after which the film is dried in vacuum at 50° C. for three hours. The film is then dried in a dessicator for three weeks.

### Preparation of Fluorescence Quenching Oxygen Detectors

As shown in FIG. 2, the oxygen sensor (100) may be incorporated into a miniature solid-state detector (200) that uses fluorescence to measure oxygen partial pressure. In one embodiment, an excitation source, such as an LED (208), fluorescence detector (210), and driving and conditioning circuitry (212) are all integrated into the device. The substrate-Y—R-Pyrene (or mixtures thereof) is excited by the excitation source with an appropriate wavelength and fluoresces. Upon exposure to oxygen the fluorescence intensity and it time decay is measured by the detector. The decay rate of fluorescence varies with the oxygen concentration.

### REFERENCES

O. Buiu, B. Serban, M. Mihaila, M. Brezeanu, and S. Costea “New Design Approach for Quantum Dot Solar Cell,” SIZEMAT2—September 19-21, 2010, Nessebar, Bulgaria.
Y. Amao, I. Okura, T. Miyashita, Bull Chem Soc. Jpn. 74, (2001) 1159.
B. I. Ipe, K. Yoosaf, G. Thomas, Pramana—journal of physics 65(5) (2005), 909.
Jolly, W. L. (1984), “Modern Inorganic Chemistry”, New York: McGraw-Hill. ISBN 0070327602.
A. M. Lazarin, Y. Gushikem, S. C. Castro, J. Mater. Chem. 10, (2000), 2526.
R. G. Pearson, “Hard and soft acids and bases” J. Amer. Chem. Soc., 85, (22), (1963), 3533.
B. Serban, M. Mihaila, S. Costea, O Buiu “New Ligand Selection Rule for Quantum Dot Functionalization,” Semiconductor Conference, 2009. CAS 2009. International, Oct. 12-14, 2009, 81-84.
L. R. D. Silva, Y. Gushikem, M. C. Gonçalves, U. P. Rodrigues-Filho, S. C. Castro, J. Appl. Polym. Sci. (1995), 58, 1669.
http://www.ias.ac.in/pramana/v65/p909/fulltext.pdf.
http://www.meta-synthesis.com/webbook/43_hsab/HSAB.html.

1. A fluorescence quenching oxygen sensor (100) comprising a support (102) having coated thereon;
(A) TiO₂ (104) having either free Ti⁺⁴ or OH groups at the TiO₂ surface; and
one or more pyrene compounds (106) represented by
Y—R-Pyrene (I)
attached to the TiO₂ surface;
wherein Y is a is a carboxylic acid group or a carboxylate group and R is an aliphatic linking group having 1 to 19 carbon atoms;
or
(B) Cu₂O (104); and
one or more pyrene compounds (106) represented by
Y—R-Pyrene (I)
attached to the Cu₂O surface;
wherein Y is a thiol group, or the anion of a thiol group and R is an aliphatic linking group having 1 to 19 carbon atoms.

2. The fluorescence quenching oxygen sensor of claim 1, wherein the pyrene is 1-pyrene.

3. The fluorescence quenching oxygen sensor of claim 1, wherein Y—R-Pyrene is represented by one or more of:

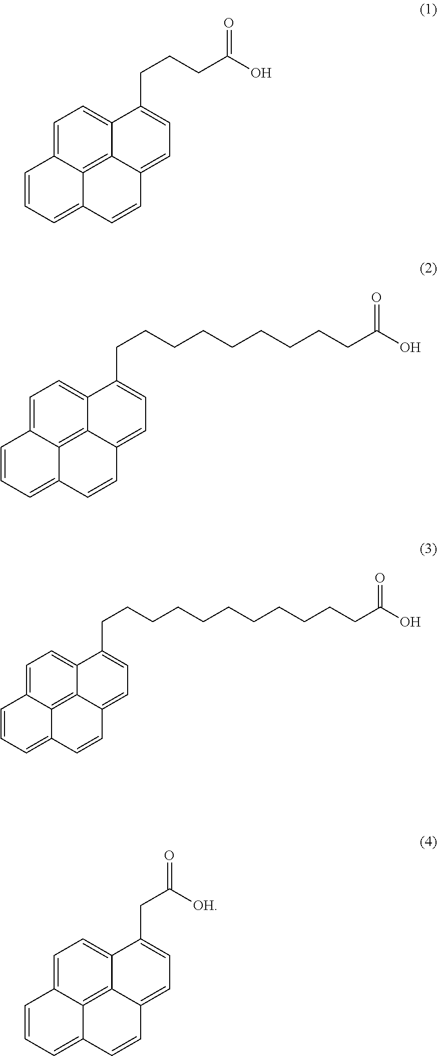 [SMILES: O=C(O)CCCc1ccc2ccc3cccc4ccc1c2c34 ; O=C(O)CCCCCCCCCc1ccc2ccc3cccc4ccc1c2c34 ; O=C(O)CCCCCCCCCCCc1ccc2ccc3cccc4ccc1c2c34 ; O=C(O)Cc1ccc2ccc3cccc4ccc1c2c34]

4. The fluorescence quenching oxygen sensor of claim 1, wherein Y—R-Pyrene is represented by one or more of:

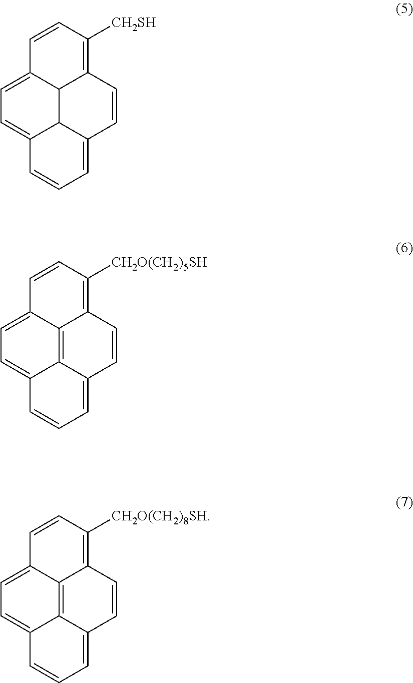

5. The fluorescence quenching oxygen sensor of claim 1, wherein Y—R-Pyrene is represented by one or more of:

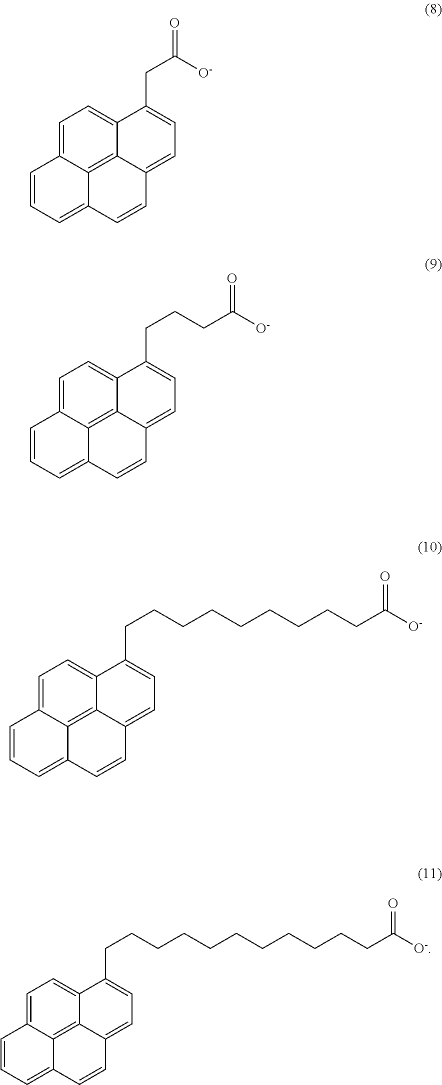

6. The fluorescence quenching oxygen sensor of claim 1, wherein Y—R-Pyrene is represented by one or more of:

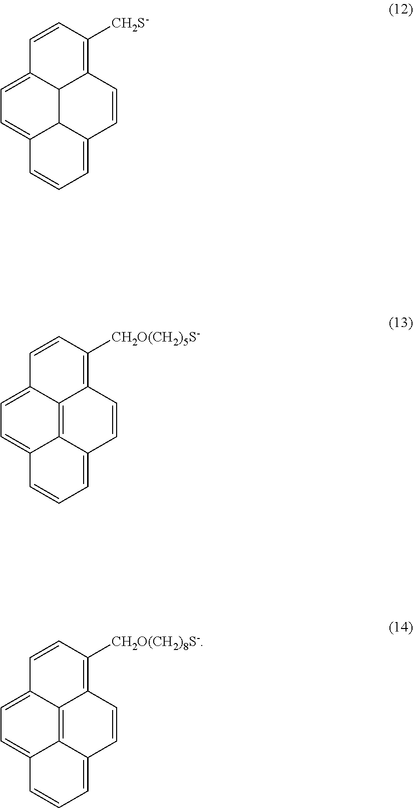

7. The fluorescence quenching oxygen sensor of any of claims 1 and 2-6, wherein the support is glass.

8. A fluorescence quenching oxygen detector (200) comprising a support (202) having coated thereon;
(A) TiO₂ (204) having either free Ti⁺⁴ or OH groups at the TiO₂ surface; and
one or more pyrene compounds (206) represented by
Y—R-Pyrene (I)
attached to the TiO₂ surface;
wherein Y is a is a carboxylic acid group or a carboxylate group and R is an aliphatic linking group having 1 to 19 carbon atoms;
or
(B) Cu₂O (204); and
one or more pyrene compounds (206) represented by
Y—R-Pyrene (I)
attached to the Cu₂O surface;
wherein Y is a thiol group, or the anion of a thiol group and R is an aliphatic linking group having 1 to 19 carbon atoms;
an excitation source (208); and
a fluorescence detector (210).

9. The fluorescence quenching oxygen detector of claim 8, wherein the excitation source is an LED.

10. The fluorescence quenching oxygen detector of claim 8 or 9 the support is glass.

11. The fluorescence quenching oxygen detector of any of claims 8-10, wherein Y—R-Pyrene is represented by one or more of: 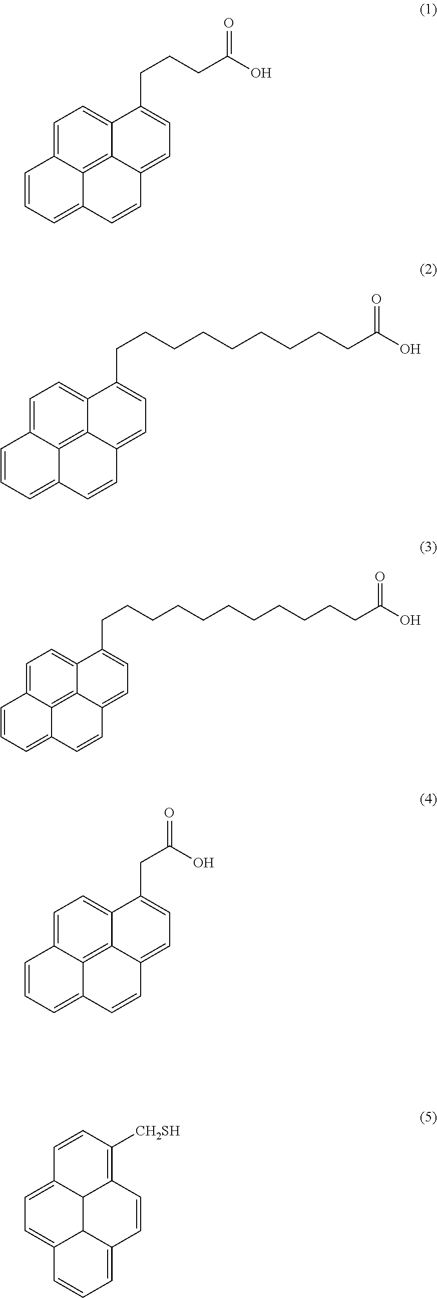 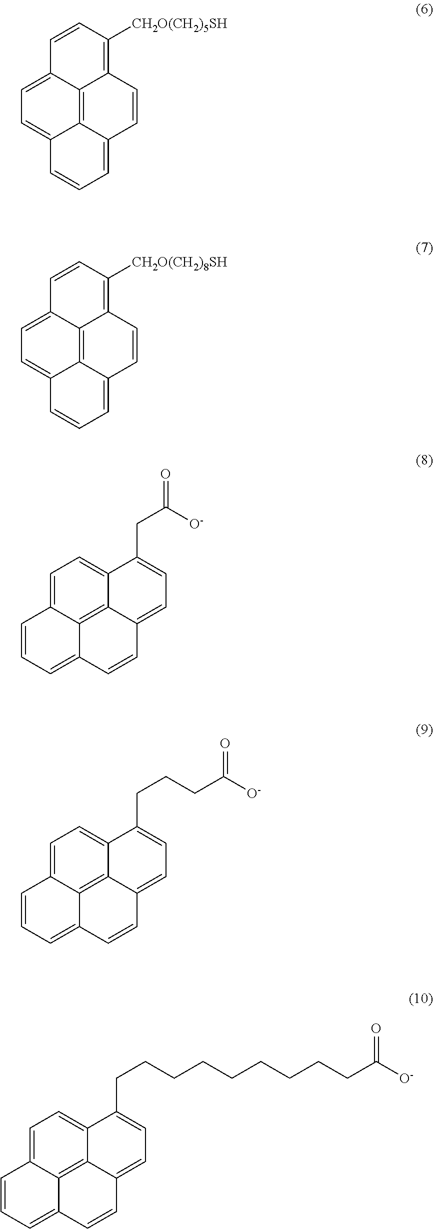 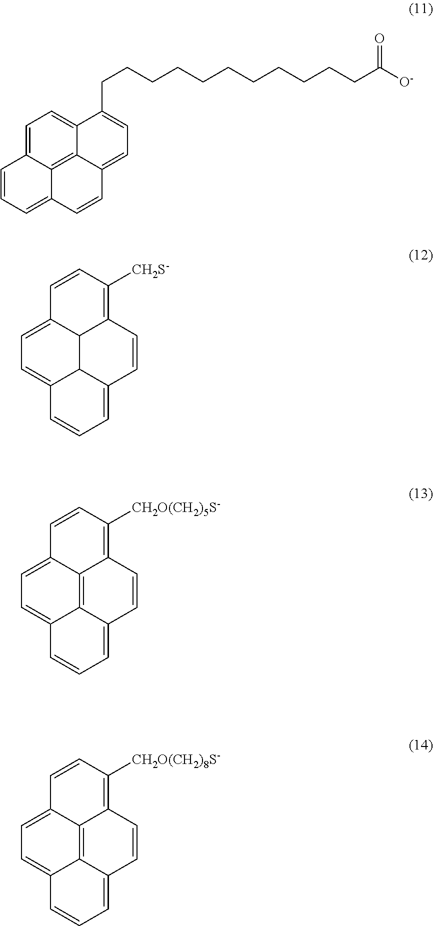
and the compound having hard or soft acid groups is TiO₂ or Cu₂O.

12. A method of preparing a fluorescence quenching oxygen sensor (100) comprising coating onto a support (102);
(A) TiO₂ having either free Ti⁺⁴ or OH groups at the TiO₂ surface (204); and
one or more pyrene compounds (206) represented by
Y—R-Pyrene (I)
attached to the TiO₂ surface;
wherein Y is a is a carboxylic acid group or a carboxylate group and R is an aliphatic linking group having 1 to 19 carbon atoms;
or
(B) Cu₂O (204); and
one or more pyrene compounds (206) represented by
Y—R-Pyrene (I)
attached to the Cu₂O surface;
wherein Y is a thiol group, or the anion of a thiol group and R is an aliphatic linking group having 1 to 19 carbon atoms;
wherein Y—R-Pyrene is represented by one or more of: 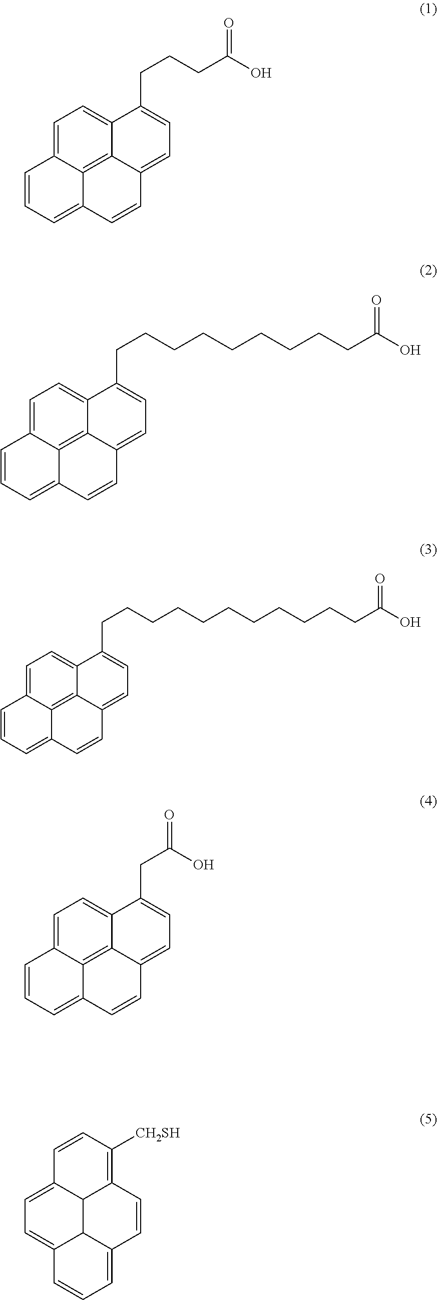 [chemical structure]
